(19) United States
(12) Patent Application Publication
(10) Pub. No.: US 2006/0032983 A1
(43) Pub. Date: Feb. 16, 2006

(54) Foreign object damage tolerant nacelle anti-icing system

(76) Inventors: Joseph Horace Brand, Mississauga (CA); William John Kirby Savage, Milton (CA)

Correspondence Address: OGILVY RENAULT LLP (PWC), 1981 MCGILL COLLEGE AVENUE, SUITE 1600, MONTREAL, QC, H3A 2Y3, CA

(21) Appl. No.: 10/893,268

(22) Filed: Jul. 19, 2004

(51) Int. Cl. B64D 15/16

(52) U.S. Cl. 244/134 R

(57) ABSTRACT

A nacelle for housing a gas turbine engine is disclosed. The nacelle comprises an inlet lip defining a leading edge of the nacelle and a conduit located within the inlet lip, the conduit having a fluid circulating therein. The fluid provides a heat source. An energy attenuating member is located within the inlet lip between the leading edge and the conduit. The energy attenuating member provides protection to the conduit from foreign object damage and is thermally conductive such that heat transfer communication between the conduit and the leading edge is provided.

### TECHNICAL FIELD

The present invention relates to de-icing and anti-icing systems for use with nacelles housing aircraft engines.

### BACKGROUND OF THE INVENTION

Turbofan nacelles typically require inlet de-icing for safety reasons. Prior art engine inlet anti-icing systems commonly employ a thermal source, such as hot air bled from the engine core or an electrical heating element, for providing heat to remove ice build-up on the inlet surfaces. However, using bleed from the engine core reduces overall engine efficiency and electrical systems draw electrical power which impose a non-propulsive load on the engine. Opportunities for improvement therefore exist.

### SUMMARY OF INVENTION

It is therefore an aim of the present invention to provide an improved anti-icing system for an aircraft engine nacelle.

Therefore, in accordance with the present invention, there is provided a nacelle for housing a gas turbine engine, the nacelle comprising: an inlet lip defining a leading edge of the nacelle; a conduit located within the inlet lip, the conduit having a fluid circulating therein, the fluid providing a heat source; and an energy attenuating member located within the inlet lip and disposed between the leading edge and the conduit, the energy attenuating member providing protection to the conduit from foreign object damage and being thermally conductive such that heat transfer communication between the conduit and the leading edge is provided.

Also in accordance with the present invention, there is provided a system for preventing ice build up on an inlet lip of a nacelle housing a gas turbine engine, the system comprising: a cavity extending within the inlet lip and partly defined by a leading edge thereof; first means for providing a fluid circulation within the cavity; a hot fluid circulating within the first means; and second means for providing heat transfer communication between the first means and the leading edge and for providing foreign damage protection to the first means, the second means filling a free space between the first means and the leading edge.

Further in accordance with the present invention, there is provided a method of producing a foreign object damage tolerant anti-icing system for an inlet lip of a nacelle housing a gas turbine engine, the method comprising the steps of: defining a circumferential passage within the inlet lip; defining a free space between the circumferential passage and a leading edge of the inlet lip; filling the free space with a material, the material having sufficient thermal conductivity to enable heat transfer communication between the circumferential passage and the leading edge and having sufficient impact energy resilience to protect the circumferential passage from foreign object damage; and connecting the circumferential passage to a system circulating a hot fluid, the hot fluid circulating through the circumferential passage being adapted to provide heat to the inlet lip through the circumferential passage and the material.

There is further provided, in accordance with the present invention, a method of preventing foreign object damage to an anti-icing system in an inlet of a nacelle for housing a gas turbine engine, the method comprising: providing a conduit defining a fluid passage within the inlet lip; defining a space between the conduit and a leading edge of the inlet lip, and disposing an energy attenuating member within the space; enabling heat transfer communication between the conduit and an outer surface of the inlet lip via the energy attenuating member; and circulating a hot fluid within the conduit.

Still other aspects of these and other inventions will become apparent upon review of the description below.

### BRIEF DESCRIPTION OF THE DRAWINGS

Reference will now be made to the accompanying drawings, showing by way of illustration preferred embodiments of the present invention in which:

FIG. 1 is a partially sectioned side elevation schematic of an aircraft engine mounted within a nacelle having an inlet lip anti-icing system in accordance with a preferred embodiment of the present invention; and

FIG. 2 is an enlarged cross-sectional view of the inlet lip anti-icing system of FIG. 1.

### DESCRIPTION OF THE PREFERRED EMBODIMENTS

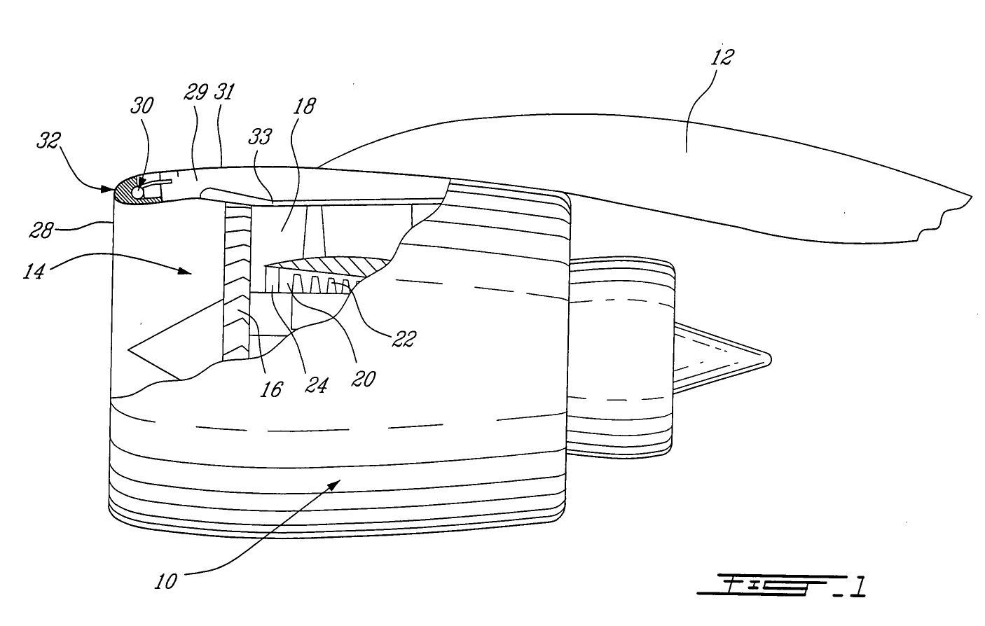

Referring to FIG. 1, a nacelle 10 of an aircraft power plant 14 is fixed to a mounting structure 12 of an aircraft. The power plant 14 will be preferably described herein as a gas turbine engine, and more particularly as a turbofan, however the nacelle inlet lip anti-icing and oil cooling system of the present invention can be used with any suitable aircraft power plant. The turbofan engine 14, as illustrated in FIG. 1, shows an upstream fan 16 that provides initial compression of the engine inlet airflow which is subsequently split into an outer annular bypass airflow passage 18 and an inner annular engine core airflow passage 20. Generally, inlet guide vanes 24 are disposed at least within the engine core airflow passage 20, upstream of a following compressor stage 22.

The nacelle 10 is generally tubular, having an outer surface 31 and an inner surface 33 substantially parallel to one another and radially spaced apart to define a hollow cavity 29 therebetween. The circumferential inner surface 33 of the nacelle 10 defines the air flow passage to the engine at the upstream end thereof, and defines the annular bypass airflow passage 18 further downstream. At the most upstream end of the nacelle 10 is disposed an inlet lip 28. Within the annular hollow cavity 29 at the inlet lip 28 of the nacelle 10 is disposed a combined anti-icing and oil cooling system 30. A combined anti-icing system and oil cooler is disclosed in the applicant's co-pending application U.S. Ser. No. 10/628,368 filed Jul. 29, 2003, the contents of which is incorporated herein by reference. While efficient, the disposition of the system is such that it could be susceptible to foreign object damage. Should such damage occur, substantial repair costs and engine and/or aircraft down time may result. A more damage tolerant system is therefore desired, and will now be described.

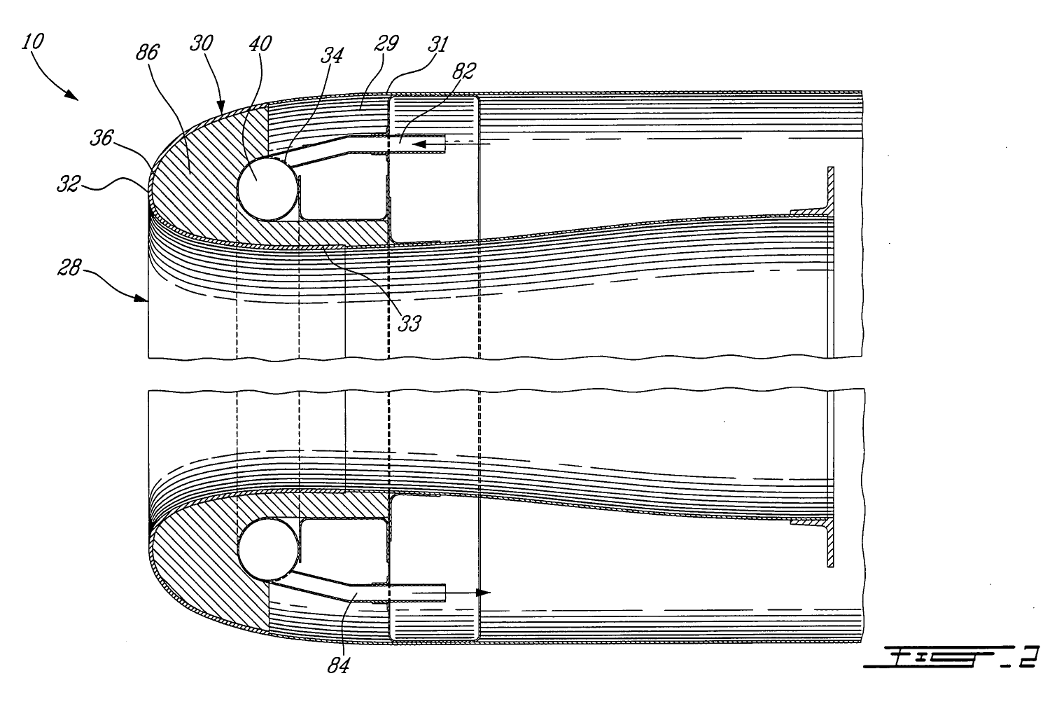

Referring to FIG. 2, the inner and outer surfaces 33 and 31 of the nacelle 10 are preferably sheet metal or composite skins integrally joined at the upstream ends thereof with an annular sheet metal lip 36 having a substantially C-shaped cross-section, thereby forming the nacelle inlet lip 28. The anti-icing/oil cooling system 30 comprises principally a circumferentially extending tube 34 defining an annular oil passage 40 which preferably extends the full circumference of the nacelle inlet lip 28 within the hollow cavity 29. At least one inlet port 82 and one outlet port 84 are provided in the tube 34 for adding and removing engine oil into the oil passage 40.

The upstream portion of the hollow cavity 29 within the inlet lip 28 includes an energy attenuating member 86, which has a high thermal conductivity such that heat transfer communication is maintained between the tube 34 and the outer surface the inlet lip. The energy attenuating member 86 is disposed between the tube 34 and the leading edge of the inlet lip, and preferably at least partially surrounds the tube 34. The energy attenuating member 86 preferably comprises a high thermal conductivity graphite foam, having a thermal conductivity similar to solid aluminum. The energy attenuating member 86 is such as to offer appropriate impact energy resilience against foreign object damage. Thus, the energy attenuating member 86 will crumple when impacted by a large foreign object striking the inlet lip 28, thereby dissipating the energy of the foreign object strike without significantly damaging the tube 34. Upon smaller foreign object damage strikes, the inlet lip of the nacelle may only be cracked or punctured by the object, and the energy attenuating member will tend to restrain the object such that normal operation of the anti-icing system will not be affected. The thermal conductivity properties of the energy attenuating member 86 allows heat transfer communication between the wall of the tube 34 and the annular sheet metal lip 36, as well as between the wall of the tube 34 and the inner and outer surfaces 33 and 31 of the nacelle 10, such that heat transfer by conduction can occur therebetween.

Hot engine oil having cooled the turbofan engine 14 is thus circulated through the oil passage 40, preferably continuously, before it is returned to the engine. Accordingly, heat transfer communication between the hot engine oil flowing through the oil passage 40 and the inlet lip icing regions of the nacelle inlet lip 28, through the high thermal conductivity material 86, allows heat from the hot engine oil to be transferred to an outer surface 32 of the inlet lip 28, thereby melting any ice formed thereon and keeping the outer surface 32 sufficiently warm in order to prevent any ice build-up, while simultaneously cooling the engine oil.

The system 30 as described thus allows the simultaneous cooling of the engine oil and de-icing of the inlet lip 28. In addition, the material 86 filling the inlet lip 28 provides foreign object damage protection to the tube 34. A small foreign object which punctures the outer surface 32 of the inlet lip 28 will likely be retained by the material 86 and as such will not interfere with the normal operation of the system 30. The material 86 will exhibit local damage only, which is easier and less costly to repair than damage to the tube 34.

A control system is provided for managing the anti-icing system to ensure that the necessary heat transfer and engine oil circulation is maintained.

In an alternate embodiment, a heat transfer fluid other than the engine oil is circulated through the passage 40, such that the tube 34 is the condenser component of a thermosyphon loop heated by a hot coil. The heat transfer fluid thus circulates through the passage 40 partly in a gaseous or vaporized form such as to be condensed therein. The heat transfer fluid possesses suitable vapor pressure characteristics, is non flammable, and is compatible with the materials it comes in contact with such as the material forming the tube 34. The heat transfer fluid also preferably has a zero ozone depletion potential (ODP) and a low global warming potential (GWP). However in this case, a conventional oil cooler is separately provided in the gas turbine engine for cooling the engine oil.

The embodiments of the invention described above are intended to be exemplary. Those skilled in the art will therefore appreciate that the forgoing description is illustrative only, and that various alternatives and modifications can be devised without departing from the spirit of the present invention. Accordingly, the present is intended to embrace all such alternatives, modifications and variances which fall within the scope of the appended claims.

1. A nacelle for housing a gas turbine engine, the nacelle comprising:
an inlet lip defining a leading edge of the nacelle;
a conduit located within the inlet lip, the conduit having a fluid circulating therein, the fluid providing a heat source; and
an energy attenuating member located within the inlet lip and disposed between the leading edge and the conduit, the energy attenuating member providing protection to the conduit from foreign object damage and being thermally conductive such that heat transfer communication between the conduit and the leading edge is provided.

2. The nacelle according to claim 1, wherein the fluid is oil from a pressurized oil system for lubricating components of the gas turbine engine, and wherein the conduit acts as an oil cooler for the gas turbine engine.

3. The nacelle according to claim 1, wherein the fluid is a heat transfer fluid which enters the conduit at least partly in a gaseous form to be condensed within the conduit.

4. The nacelle according to claim 1, wherein the conduit is annular.

5. The nacelle according to claim 1, wherein the conduit comprises a tube fixed within the inlet lip.

6. The nacelle according to claim 2, wherein a control system regulates oil flow in the conduit, the control system providing oil leakage prevention in the event that damage to the conduit is detected.

7. The nacelle according to claim 1, wherein the nacelle is operably engageable to an aircraft.

8. The nacelle according to claim 1, wherein the energy attenuating member comprises a graphite foam.

9. The nacelle according to claim 8, wherein the graphite foam has a thermal conductivity similar to that of solid aluminum.

10. The nacelle according to claim 1, wherein a portion of the energy attenuating member is disposed on an outer surface of the nacelle to increase heat transfer out of the fluid.

11. A system for preventing ice build up on an inlet lip of a nacelle housing a gas turbine engine, the system comprising:
a cavity extending within the inlet lip and partly defined by a leading edge thereof;
first means for providing a fluid circulation within the cavity;
a hot fluid circulating within the first means; and
second means for providing heat transfer communication between the first means and the leading edge and for providing foreign damage protection to the first means, the second means filling a free space between the first means and the leading edge.

12. The system according to claim 11, wherein the hot fluid is lubricant from a pressurized lubricant system for lubricating components of the gas turbine engine, the first means providing lubricant cooling for the gas turbine engine.

13. The system according to claim 11, wherein the hot fluid enters the first means at least partly in a vapor form such as to be condensed within the first means.

14. The system according to claim 11, wherein the first means are defined along a circumference of the inlet lip.

15. The system according to claim 11, wherein the second means has a thermal conductivity similar to that of solid aluminum.

16. A method of producing a foreign object damage tolerant anti-icing system for an inlet lip of a nacelle housing a gas turbine engine, the method comprising the steps of:
defining a circumferential passage within the inlet lip;
defining a free space between the circumferential passage and a leading edge of the inlet lip;
filling the free space with a material, the material having sufficient thermal conductivity to enable heat transfer communication between the circumferential passage and the leading edge and having sufficient impact energy resilience to protect the circumferential passage from foreign object damage; and
connecting the circumferential passage to a system circulating a hot fluid, the hot fluid circulating through the circumferential passage being adapted to provide heat to the inlet lip through the circumferential passage and the material.

17. The method according to claim 16, wherein the step of connecting the circumferential passage comprises permitting fluid flow communication between the circumferential passage and a pressurized oil system of the gas turbine engine, the hot fluid being oil from the gas turbine engine.

18. A method of preventing foreign object damage to an anti-icing system in an inlet of a nacelle for housing a gas turbine engine, the method comprising:
providing a conduit defining a fluid passage within the inlet lip;
defining a space between the conduit and a leading edge of the inlet lip, and disposing an energy attenuating member within the space;
enabling heat transfer communication between the conduit and an outer surface of the inlet lip via the energy attenuating member; and
circulating a hot fluid within the conduit.
